(19) United States
(12) Patent Application Publication
(10) Pub. No.: US 2020/0286333 A1
(43) Pub. Date: Sep. 10, 2020

(54) ELECTRONIC GAMING SYSTEM USING HISTORICAL EVENT DATA

(71) Applicant: Ainsworth Game Technology Limited, Newington (AU)

(72) Inventor: David Waters, Las Vegas, NV (US)

(21) Appl. No.: 16/880,854

(22) Filed: May 21, 2020

Related U.S. Application Data
(63) Continuation of application No. 16/273,758, filed on Feb. 12, 2019.
(60) Provisional application No. 62/629,608, filed on Feb. 12, 2018.
(60) Provisional application No. 62/699,727, filed on Jul. 17, 2018.

(51) Int. Cl. G07F 17/32

(52) U.S. Cl. CPC G07F 17/3244; G07F 17/3288; G07F 17/3267; G07F 17/3213

(57) ABSTRACT

An electronic gaming system for pari-mutuel wagering includes an electronic gaming machine, including a display, one or more input devices, a wager acceptor and a controller coupled to the display, the one or more input devices and the wager acceptor. The controller is configured to control the display to display a plurality of wager options, each of the wager options divided into a set of wagers, and to determine a selection of one of the wager options via the one or more input devices, a first wager of the set of wagers of at least one of the wager options associated with a first set of awards and a second wager of the set of wagers of at least one of the wager options associated with a second set of awards. The first set of awards is determined based on the results of a first plurality of historical events, and the second set of awards is determined based on the results of a second plurality of historical events.

This application is a continuation of U.S. patent application Ser. No. 16/273,758, filed Feb. 12, 2019, which application claims the benefit of U.S. Provisional Patent Application No. 62/629,608, filed Feb. 12, 2018, and U.S. Provisional Patent Application No. 62/699,727, filed Jul. 17, 2018, all of which are hereby incorporated by reference in their entirety.

### BACKGROUND

This patent is directed to an electronic gaming system for playing a game using historical event data, and, in particular, to an electronic gaming system for playing a game that permits an amusement display and uses historical event data with pari-mutuel wagering.

Many players in the United States and elsewhere enjoy wagering on sports events, and in particular racing events, such as horse racing, dog racing, etc. Such wagering is traditionally carried on at the location of the racing event, such as a horse track or dog track. Alternatively, the wagering may occur at a location remote to the racing event, such as an off-track betting establishment, where a live transmission of the racing event is displayed to the persons at the off-track establishment. Particularly exciting is the ability to place a wager on a race and then to see that race run shortly thereafter.

Unfortunately, it is not always possible for a player to find opportunities to wager on live racing events. For example, races typically are not conducted around the clock, such that there may be times during the day when a player may have the personal time to engage in wagering on racing events, but this may not coincide with the time during which the racing events are conducted. Additionally, there are delays, typically about 20 or 30 minutes, between live races during which a player cannot obtain the immediate excitement of wagering on a race and then seeing the race run. Further, while horse racing and dog racing can occur over a wide range of weather conditions (in fact, the conditions of the track and the individual horse's or dog's ability to handle these conditions is a factor in handicapping a race), the conditions can be so inconsistent or so adverse that races cannot be conducted safely.

Consequently, some jurisdictions have permitted players to wager on live races run in other jurisdictions. Still other jurisdictions have permitted players to wager on historical event data. That is, the player may be permitted to wager on the outcome of a race that was conducted previously. As such, the player may be able to wager on races even during times of the day where races are not conducted, or at times when conditions do not permit live racing.

Typically, when a player wagers on historical event data, certain information about the race and the competitors will be provided to the player, while other information will not. For example, the statistics regarding a particular horse that is running in a particular race may be shared with the player, but the horse's identity or the jockey's identity may be withheld. Similarly, the track conditions may be provided, but the identity of the track may be withheld.

In addition, it is conventional to provide some display of the race as part of the historical event data wagering. In some instances, this display may be in the form of a video that was recorded at the time the event occurred. In other situations, the display may be computer-generated animation based on information that was recorded at the time the event occurred. A computer-generated animation may be used where there is no video record, or may be used to further preserve the anonymity of certain aspects of the race, such as the identity of the horses, the jockeys and/or the track.

While wagering on historical event data can be conducted by groups of players in a fashion similar to wagering on live events, it is possible for individual players to wager on historical events at gaming machines specially designed for this purpose. These machines permit the player to wager on a race selected from a database of recorded races, and then provide a payout to the player based on the outcome of the race. It is even possible for these historical event data gaming machines to display other amusement displays along with or instead of the recorded video or computer-generated animation to act as an indicator of the player's success.

One common amusement display is based on a slot-machine display, wherein a plurality of game symbols are arranged in a plurality of columns (also referred to as reels, in recognition of the terminology of the mechanical/electro-mechanical gaming machines) with combinations displayed to the player to coincide with their success on the wagering game. These amusement displays are not always successful, because players can become confused when the amusement display does not reflect the operation of the kind of slot machine play that they are used to seeing.

It would be advantageous to overcome or substantially ameliorate one or more of the obstacles to providing an electronic gaming machine that displays a slot-style amusement display while permitting wagering on historical event data on a pari-mutuel basis, or at least to provide a useful alternative.

### SUMMARY

According to one aspect, an electronic gaming system for pari-mutuel wagering includes an electronic gaming machine, including a display, one or more input devices, a wager acceptor and a controller coupled to the display, the one or more input devices and the wager acceptor. The controller is configured to control the display to display a plurality of wager options, each of the wager options divided into a set of wagers, and to determine a selection of one of the wager options via the one or more input devices, a first wager of the set of wagers of at least one of the wager options associated with a first set of awards and a second wager of the set of wagers of at least one of the wager options associated with a second set of awards. The first set of awards is determined based on the results of a first plurality of historical events, and the second set of awards is determined based on the results of a second plurality of historical events.

According to another aspect, a method of operating an electronic gaming system for pari-mutuel wagering includes displaying a plurality of wager options, each of the wager options divided into a set of wagers, and determining a selection of one of the wager options via the one or more input devices, a first wager of the set of wagers of at least one of the wager options associated with a first set of awards and a second wager of the set of wagers of at least one of the wager options associated with a second set of awards. The method also includes determining the first set of awards based on the results of a first plurality of historical events; and determining the second set of awards based on the results of a second plurality of historical events.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a schematic of a system of electronic gaming machines according to an embodiment;

FIG. 2 is a block diagram of an electronic gaming machine that may be used in the system of FIG. 1;

FIG. 3 is a simulated screenshot of a game display as displayed on an electronic display of one or more of the gaming machines according to the system of FIG. 1;

FIG. 4 is a flowchart of an aspect of a method of operating the system of electronic gaming machines using in the system of FIG. 1;

FIG. 5 is a simulated screenshot of a handicapping data display as displayed on an electronic display of one or more of the gaming machines according to the system of FIG. 1;

FIG. 6 is a simulated screenshot of a manual handicapping screen for selection of horses for a historical horse race as displayed on an electronic display of one or more of the gaming machines according to the system of FIG. 1;

FIG. 7 is a simulated screenshot of historical game event information and an amusement display as displayed on an electronic display of one or more of the gaming machines according to the system of FIG. 1;

FIG. 8 is a simulated screenshot of the amusement display at the completion of the game as displayed on an electronic display of one or more of the gaming machines according to the system of FIG. 1;

FIG. 9 is a schematic view of an award pattern;

FIG. 10 is a schematic view of a plurality of award patterns;

FIG. 11 is a flowchart of another aspect of a method of operating the system of electronic gaming machines using in the system of FIG. 1;

FIG. 12 is a flowchart of a further aspect of a method of operating the system of electronic gaming machines using in the system of FIG. 1;

FIG. 13 is a schematic view of a relationship between wagers, take, pools, prizes and counters;

FIG. 14 is a perspective view of an alternative embodiment of an electronic gaming machine; and

FIG. 15 is a block diagram of the electronic gaming machine of FIG. 14.

### DETAILED DESCRIPTION OF VARIOUS EMBODIMENTS

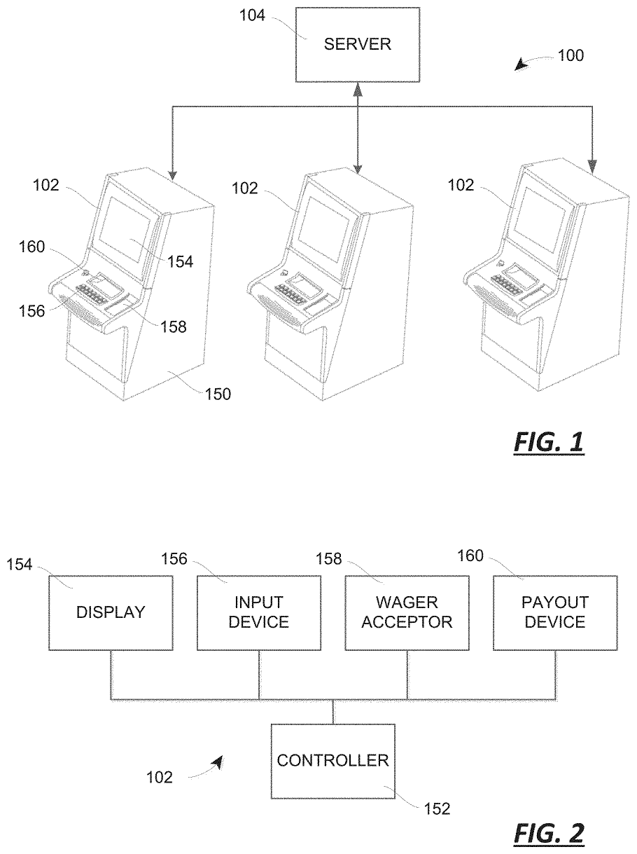

FIG. 1 illustrates a system 100 used for providing an amusement display while permitting pari-mutuel wagering on historical event data. The system 100 includes one or more electronic gaming machines (or terminals) 102 on which the game is played. The system 100 may include one or more network computers or servers 104 that are connected to the electronic gaming machines 102 so that there is communication between the electronic gaming machines 102 and the server(s) 104. The gaming machines 102 and the server(s) 104 may be disposed in the same geographic location (e.g., a common building) or may be disposed in remote geographic locations (e.g., different buildings, cities, or even countries).

According to certain embodiments, the server(s) 104 may be defined by one or more processors that may be programmed to perform the actions of the server 104. In fact, the server 104 may be defined in part by electrical circuit components and in part by a processor(s) programmed to perform the actions of the server 104. The instructions by which the processor(s) is/are programmed may be stored on a memory associated with the processor, which memory may include one or more tangible non-transitory computer readable memories, having computer executable instructions stored thereon, which when executed by the processor, may cause the one or more processors to carry out one or more actions.

According to an embodiment illustrated in FIGS. 1 and 2, one or more of the electronic gaming machines 102 include a cabinet 150 in which is disposed or mounted an electronic game controller 152 (FIG. 2). Similar to the server 104, the controller 152 may be defined by one or more electrical circuit components, may be defined by one or more processors that may be programmed to perform the actions of the controller 152, or in part by electrical circuit components and in part by a processor(s) programmed to perform the actions of the controller 152. The instructions by which the processor(s) is/are programmed may be stored on a memory associated with the processor, which memory may include one or more tangible non-transitory computer readable memories, having computer executable instructions stored thereon, which when executed by the processor, may cause the one or more processors to carry out one or more actions.

The controller 152 is coupled to and in communication with one or more displays 154, one or more input devices 156, one or more wager acceptors 158 and one or more award payout devices 160. The one of more input devices 156 may be in the form of one or more buttons, or may be in the form of a touch screen that is used in association with the display 154. Further, the wager acceptor 158 may be in the form of a coin acceptor, a paper currency (or bill) acceptor, and a ticket reader and/or printer. The ticket printer may also define an award payout device 160. The controller 152 may be coupled to the display(s) 154, input device(s) 156, wager acceptor(s) 158, and payout device(s) 160 via a common bus, or the controller 152 may be connected to each separately. Further variations on the electronic gaming machine and the display, input devices, wager acceptors, and payout devices are provided below.

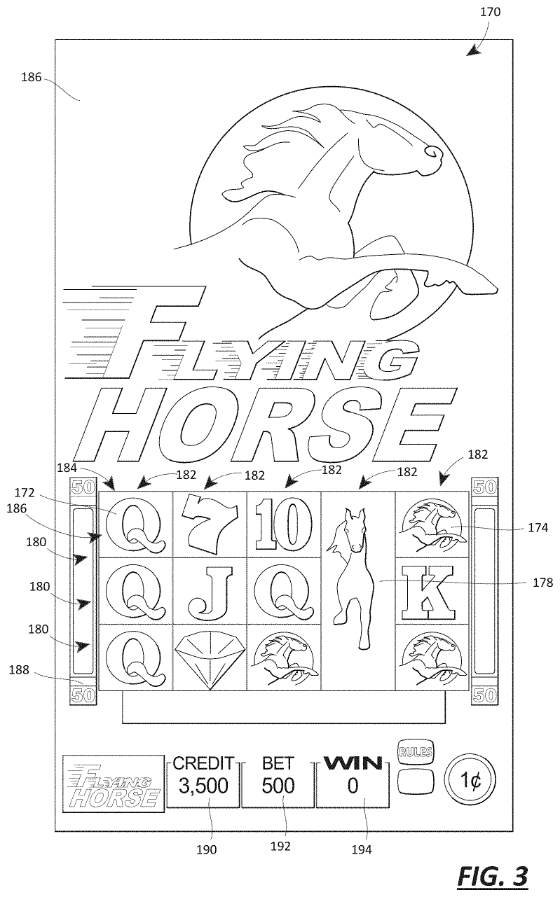

As mentioned above, the electronic gaming machine 102 is configured to provide a slot-style amusement display with a game that uses historical event data to determine results and awards. FIG. 3 is an embodiment of a slot-style amusement display that may be displayed on the display 154 as part of such a game using historical event data. The display includes one or more configurations of game symbols, one or more of the configurations or combinations of game symbols being associated with a game outcome, the game outcome being associated with a value award payable to a player.

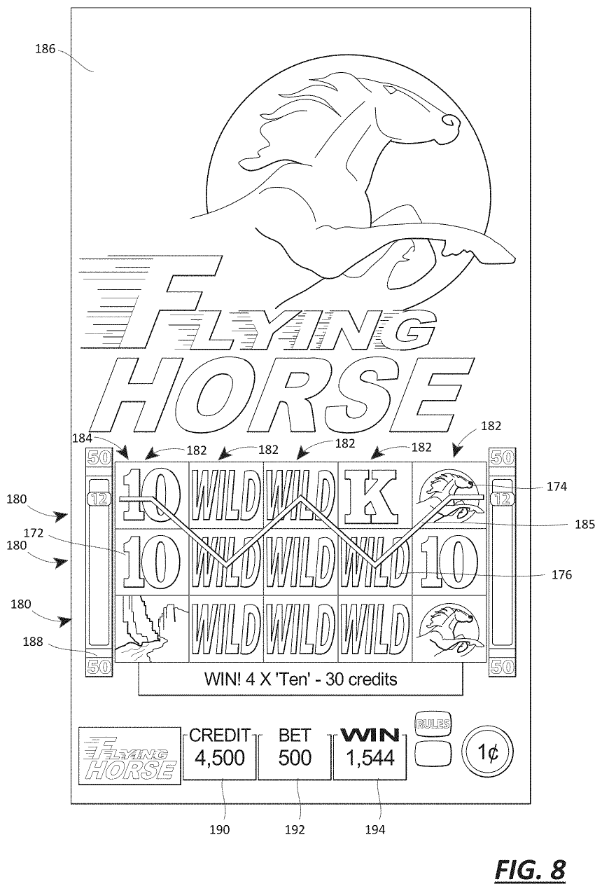

According to the embodiment illustrated in FIGS. 3 and 8, the amusement display 170 includes a plurality of game symbols 172, 174, 176, 178, which symbols 172, 174, 176, 178 are arranged in a plurality of rows 180 and columns 182 to define an array 184. The columns 182 may each correspond to the reels in a mechanical or electromechanical display, and may be referred to as reels such herein. According to the illustrated embodiment, the game symbols are organized into three rows and five columns or “reels” (a 5×3 array), although other arrays, such as a 3×3 or 4×3, may be used in the alternative.

Each of the game symbols 172, 174, 176, 178 is disposed in a game position 186 (see FIG. 3). The game positions may be demarked with a solid border or boundary line. According to the illustrated embodiments, the boundary lines between game symbols 186 in the same column 182 may be not be visible or there may be no boundaries. It is also possible for the boundary lines between game symbols in game positions along a row 180 to be omitted or not visible.

The game symbols 172, 174, 176, 178 are non-limiting examples of game symbols that may be present in a play of the game of the illustrated embodiment. For example, the game symbols may represent card ranks (or ordinal values) 172 or objects 174. The game symbols may also include scatter symbols used as part of the trigger event. Further game symbols may be WILD symbols 176 (see FIG. 8), which may appear in place of other game symbols. As illustrated in FIG. 3, the game symbols may even extend across more than one game position, as is the case with game symbol 178.

According to the illustrated embodiment, the game symbols 174, 178 may be defined according to a theme, such as a Western or horse theme, as illustrated. Accordingly, the object game symbols 174 may include images of horses or canyons, for example. In addition, the extended symbol 178 includes images of a charging horse.

As mentioned above, the amusement display provides one or more configurations of game symbols that are associated with a game outcome that is itself associated with a value award to the player. In particular, the configurations associated with the game outcomes are those that are arranged along what is referred to as “an active payline.” In slot machine games, an active payline is a payline on which the player has placed a wager or bet; in the slot-machine amusement display, active paylines are those that are used to directly display to players the results of their wagers on the historical event data. See, e.g., FIG. 8 for an example of how an active payline 185 may be displayed to the player. While one exemplary payline is illustrated in FIG. 8, it will be recognized that additional paylines may be included in other embodiments.

Only game symbols 172, 174, 176, 178 arranged along a payline will be used to convey the results of the historical data to the player. For example, an arrangement of three or more instances of the same game symbol on an active payline (e.g., the “10” in combination with three instances of “WILD” on the payline of FIG. 8) may be associated with a value award, with different game symbols resulting in lower or higher value awards. Game symbols display in game positions that are not part of the active paylines may be used to complete the amusement display, but may not impart any information to the player regarding the results according to certain embodiments.

The controller 152 may control the display 154 to display additional information, other than the elements of the slot-style amusement display. For example, the controller 152 may control the display 154 to display a theme image 186. Even though the paylines are only used as part of the display as a signal to the player that a win has occurred, the image displayed may also include a payline indicator 188 to indicate how many paylines are being included as part of the amusement display. Further, the image may include information regarding a player's credit balance 190, a present bet level 192, and a current win level 194. Other illustrations may be tied to simulated buttons or other input devices that are used by the player to indicate their selections to the controller 152 as explained in detail below.

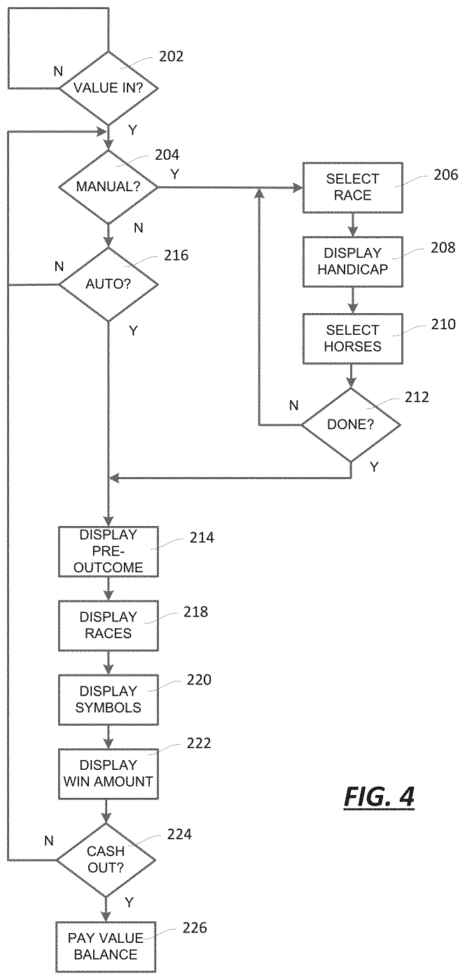

As mentioned above, the electronic gaming machines 100 play a game using historical event data. FIGS. 4, 11 and 12 illustrate an exemplary method for playing one such game.

FIG. 4 illustrates the portion of the method carried out at the gaming system 100, and in particular by the controller 152. This portion of the method begins at block 202, where the controller 152 determines whether the wager acceptor 158 has received value from the player. Stated slightly differently, the controller 152 determines if the player has deposited value in the wager acceptor 158. In any event, if value has been received, the controller 152 stores the amount of the value deposited (locally and/or at the server 104), and the method continues at block 204. Until such time as value has been deposited, the method remains at block 202, during which time the controller 152 may also control the display 154 to display animations to instruct players as to the operation of the machine 102 or to entertain.

At block 204, the controller 152 determines if the player has used the input device 156 to select manual handicapping of the races used to determine the outcome of the game. For example, the input device 156 may be a touchscreen, and when the player touches a particular region of the touchscreen 156, the controller 152 determines that the player has selected manual handicapping. If the controller 152 determines that the player has selected manual handicapping, the method proceeds to block 206. According to certain embodiments, if the controller 152 determines that the player has selected manual handicapping, then the player must complete the steps of manual handicapping, as outlined below, before the player can proceed further.

At block 206, the controller 152 controls the display 154 to display one or more of the races that are used to determine the results of the game. For example, according to one embodiment, ten races are used for each game; according to another embodiment, eight races may be used for each game. Thus, the controller 152 may control the display 154 to display to the player options for each of the races and instructions for use of the input device(s) 156 to select one of the races. Once the controller 152 determines that one of the races has been selected via the input device(s) 156, the method proceeds to block 208.

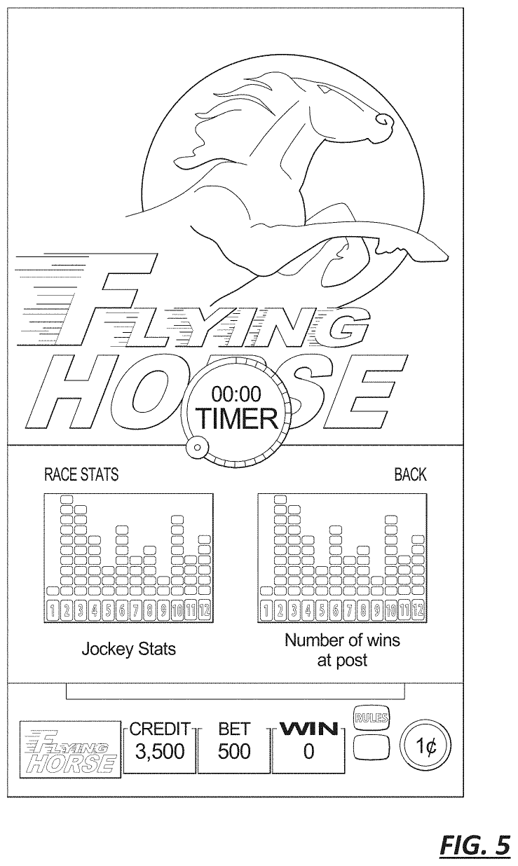

At block 208, the player may be provided with handicap data relating to the horses running in the race selected at block 206. See FIG. 5. According to some embodiments, the player may need to select an option to view the handicap data, using the input device 156 for example. According to other embodiments, the handicap data may be provided every time the player selects the manual handicapping option at block 204. According to one embodiment, there are a plurality of groups of handicapping data, and a plurality of items of handicapping data in each group, and the controller 152 selects (e.g., randomly) a subset of the groups to display to the player via the display 154. According to certain embodiments, the option to view the handicapping information can be selected only once (per race). Furthermore, according to at least one embodiment, the handicapping information is viewable by the player for a limited period (e.g., 10 seconds).

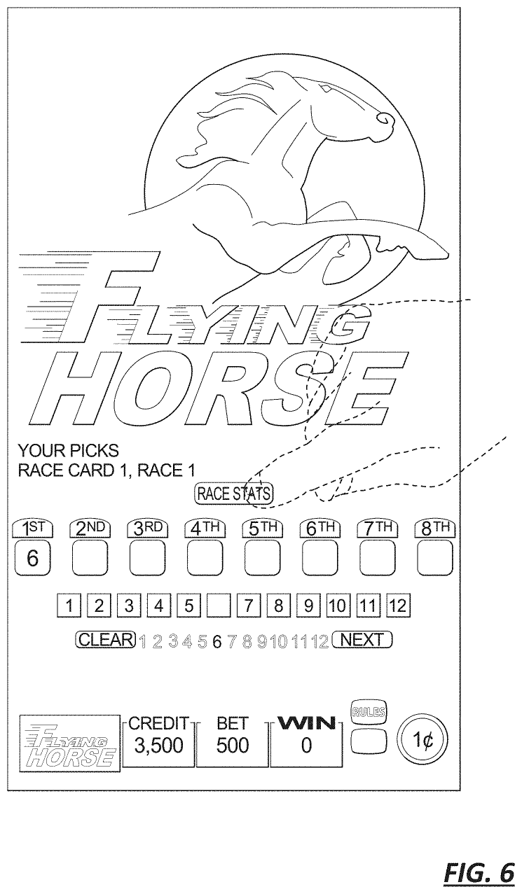

At block 210, the controller 152 controls the display 154 to display the horses that are running in the race selected at block 206. See FIG. 6. For example, according to one embodiment, each race may have twelve horses of which the player can select eight. Thus, the controller 152 may control the display 154 to display to the player options for eight horses and instructions for use the input device(s) 156 to select one of the twelve horses for each of the eight options. According to certain embodiments, the player may be required to select certain horses at block 210 (e.g., the horses the player expects to be in the first, second and third final race positions), and then the remaining horses may be selected automatically, for example according to handicap data or randomly. Once the controller 152 determines that all of the eight options have been selected via the input device 156, the method may proceed to block 212. According to certain embodiments, the controller 152 may permit the player to clear their selections and start over before proceeding to block 212 and the next race.

As illustrated in FIG. 4, blocks 208 and 210 follow sequentially—i.e., the controller 152 provides the handicapping data (if the player so elects, according to certain embodiments) at block 208 and then determines which horses the player has selected at block 210. The method is not limited to only such a sequential ordering of the actions at blocks 208 and 210. For example, according to certain embodiments, the controller 154 may determine during block 210 that the player has used the input device 156 to access the handicap data, in which case block 208 may actually be performed during the performance of the actions of block 210. Consequently, it will be recognized that the order of these actions in FIG. 4 should be taken as non-limiting.

At block 212, the controller 152 determines if the player has completed selection of horses for all of the races. If the controller 152 determines that the player has not selected horses for all of the races, then the method returns to block 206 and displays the options for the remaining races. Alternatively, if the controller 122 determines that the player has selected horses for all of the races, the method continues to block 214.

As illustrated in FIG. 4, the method may also proceed to block 214 from block 216. That is, if the controller 152 determines at block 204 that the player has not used the input device 156 to select manual handicapping, then the controller 152 determines at block 216 if the player has used the input device to select an automatic (or auto) handicapping feature. For example, where the gaming device 102 is designed to provide hardware similar to a slot-style gaming machine, the automatic handicapping feature may be selected by depressing an input device 156 in the form of a “spin” button, whether that button is a physical mechanism or a region of a touchscreen associated with the display 154. According to the automatic handicapping feature, the controller 152 selects the horses for each of the races used to determine the outcome of the game without player input. For example, the controller 152 may select the horses based on the outcome expected based on the handicapping data. As a further alternative, the controller 152 may select the horses at random in response to the player's selection of the automatic handicapping feature. After the controller 152 selects horses for all of the races, the method would then proceed from block 216 to block 214.

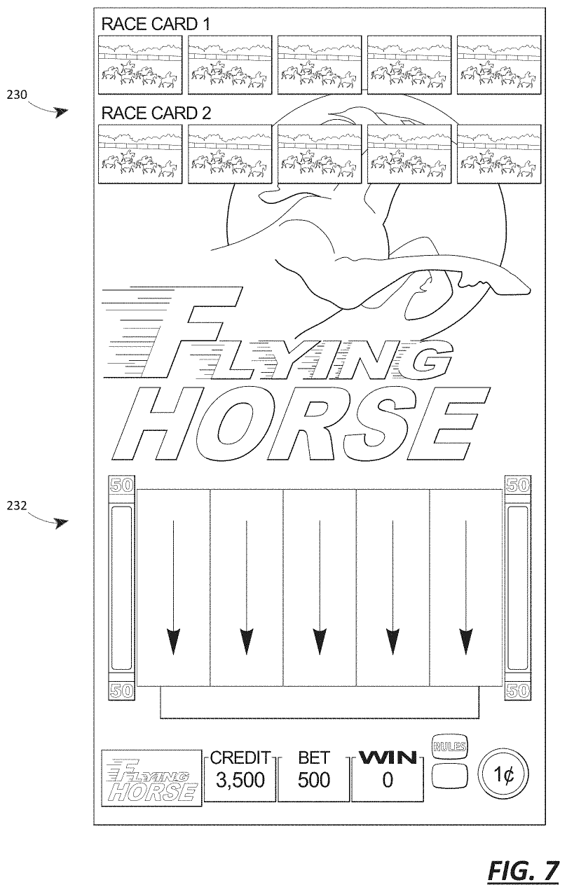

At block 214, the controller 152 may control the display 154 to display a pre-outcome animation. See FIG. 7. For example, the pre-outcome animation may include, in at least a portion 230 of the display 154, an image representative of each of the races in a pre-race state. The pre-outcome animation also may include, in at least a different portion 232 of the display 154, animations of one, some or all of the reels 182 of the amusement display spinning. According to certain embodiments, the portion 232 of the pre-outcome animation relating to the amusement display and the portion 230 relating to the races are displayed in different regions of a single display; in other embodiments, the portions 230, 232 may be displayed in different displays, and the displays may even include a first display in the cabinet 150 and a second display in a top box or topper disposed on the cabinet 150. According to a still further option, the player may be able to select whether to display the amusement display only or the race display only on the display(s) 154.

The controller 152 then may control the display 154 to display video for each of the races that are considered as part of the determination of the outcome of the game at block 218. This video may be a computer animation generated using the historical event data, or the video may have been recorded or captured at the time the historical event occurred (e.g., a film or television broadcast). These animations may include the entirety of the race associated with the historical event data, or only a portion of the race associated with the historical event data (e.g., the last 5 seconds of the race).

According to certain embodiments, the display of the historical events may occur while the controller is also controlling the display 154 to display one, some or all of the reels 182 in the amusement display spinning at block 220 (i.e., the actions to blocks 218 and 220 may occur simultaneously). According to some embodiments, the display of the historical event may be completed at the same time the controller 154 controls the display to display all of the symbols at block 222 to provide an indication of the amount won, if any (i.e., the actions at blocks 218, 220 may complete simultaneously). According to other embodiments, the player may selected to display only the races or only the reels (i.e., either block 218 or 220) at one time, with the option to display the other at another time (e.g., the player may switch back and forth between the races and the reels during blocks 218, 220, or may elect to watch the races and then the reels to their completion).

At block 222, the controller 152 controls the display 154 to display the amount won by the player. As the amount won is associated with the results of the individual races, the controller 152 may control the display 154 to display the results of the races. In addition or instead, the controller 152 may control the display 154 to display a configuration of game symbols in the game array 184 of the amusement display. See FIG. 8.

As part of the display of results, the system 100 must make a determination of the amount won by the player, which determination may occur at the controller 152 of the machine 102 and/or the server 104. This determination may occur at any point after the player has made his or her selections at blocks 212, 216. For example, once the player's selections are known, the controller 152 may compare this to the race results and make a determination about the amount won, even before displaying the pre-outcome display at block 214. Alternatively, the determination may be made at some other time before the controller 152 controls the display 154 to display the results of the races, in the form of a video recording, a computer-generated animation or an amusement display, at block 222.

According to embodiments of the system 100, the determination of the win amount may be based not on the top three places in the finishing order of the horses in each of the races. Instead, the win amount may depend on the finishing order of the horses when compared with a predetermined pattern of non-standard finishing positions (e.g., not the first or top three finishing positions in each race).

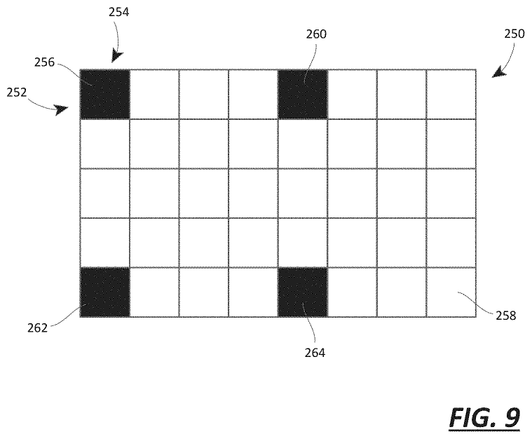

To illustrate this point, FIG. 9 includes an array or grid 250 (which may also be referred to as a race card) where each row 252 of the array 250 represents a different race within a group of races (e.g., five races as illustrated), and each column 254 represents a final position for a competitor (e.g., a horse or dog) in that race. For instance, the horse finishing first in the first race would be identified with a cell 256 located in the top row and the leftmost column, and the horse finishing eight in the fifth race would be identified with a cell 258. It will be recognized that the player's selections made either manually or automatically may be discussed with reference to such an array 250, as may the results of the races. It is not a requirement of the system 100 that an array 250 be used to store the player's sections and/or the final results, but the array 250 has been adopted for ease of discussion and could be adopted for purposes of operation of the system 100 as well.

As illustrated in FIG. 9, four cells 256, 260, 262, 264 have been filled in black. These four cells 256, 260, 262, 264 represent the pattern in which the player's selections must match the final race results to result in an award. That is, the player's selections for the horse placing first in the first race (cell 256), the horse placing fifth in the first race (cell 260), the horse placing first in the fifth race (cell 262), and the horse placing fifth in the fifth race (cell 264) must match the final race results for the pattern represented in FIG. 9 to be achieved. If this pattern is achieved (or matched), then the award associated with the pattern would be awarded to the player that matched the pattern.

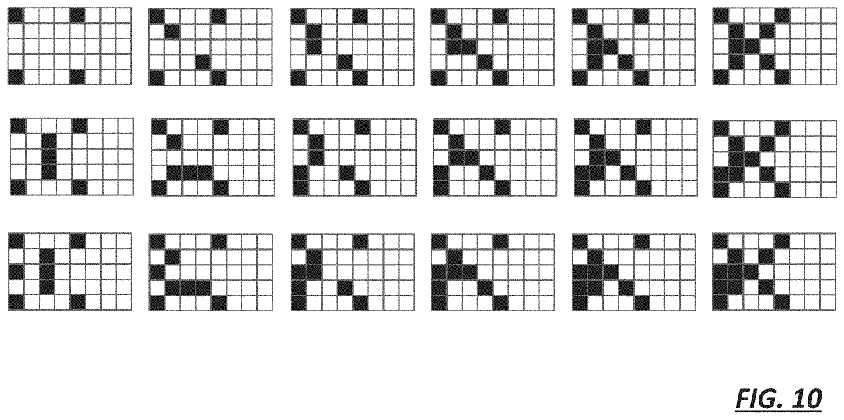

While a single pattern has been illustrated in FIG. 9, it will be recognized that the player's selections and the race results may be compared to a plurality of patterns to determine a plurality of awards or prizes. FIG. 10 illustrates a group or set of 18 patterns that may be used when comparing the player's selections with the race results to determine whether an award will be paid, with the pattern of FIG. 9 included in the top left corner. It should be further noted that each award may be funded in a pari-mutuel fashion by depositing the player's wagers into a pool (after deducting the house take) that is associated with a plurality of prizes, at least one prize associated with each of the patterns, for example, and paying out the prize from the pool when a player's selections match the final race results in the fashion identified by the pattern. As each of the patterns in the set or group of patterns in the embodiment illustrated in FIG. 10 is distinguishable from the other patterns, it would be possible for a player to win only one of the prizes associated with this group or set of patterns. Thus, the set or group of patterns of the embodiment illustrated in FIG. 10 may be described as having a single outcome.

Further, the awards associated with the patterns may be sized in accordance with the number of matches that must occur between the player's selections and the final race results. For example, the award associated with the pattern in the top left corner of FIG. 10 may be much smaller than the award associated with the pattern in the bottom right corner of FIG. 10. Moreover, it is not necessary that the awards associated with the patterns increase, for example, in a linear fashion; for instance, the differences between the awards associated with the final five patterns may be significantly larger relative to the differences between the awards associated with the other patterns. The differences between the awards associated with the final five patterns may also be different relative to other members of the group of awards associated with the final five patterns in such a circumstance.

The use of patterns of non-standard finishing positions may allow for player skill, while making it more difficult for that skill to influence the results than in more traditional handicapping methods, although the patterns illustrated in FIG. 10 still favor those who match more horses that place first, second or third. When combined with the fact that a plurality of races are used to determine the outcome for one wager, the system limits or prevents cheating and advantage play while maintaining exact mathematical odds/probabilities for a more realistic play experience.

In fact, the patterns used for determining the outcome may be matched to previously established patterns used in gaming machines using, for example, bingo results. By doing so, the development time for converting animations used in a gaming machine using bingo results, for example, for use in an amusement display for a gaming machine using historical event data may be reduced.

Returning to FIG. 4, the controller 152 determines at block 224 if the player has actuated the input device 156 to indicate their intention to stop play. For example, the player may actuate a cash-out button or a region of a touchscreen associated with an illustration of a cash-our button. If the controller 152 determines that the player has selected the cash-out option, then the method continues to block 226, and the controller 152 controls the award payout device 160 to pay the stored value balance to the player. Alternatively, if the controller 152 determines that the player has not selected the cash-out option, the method returns to block 204 (or alternatively, may permit additional value to be added to the player's balance at block 202).

In addition to the actions described in FIG. 4, the method of operation of the gaming system 100 may also include additional actions. For example, the method may include an option for the player to view his or her horse selections and the race results for each of the races that contributed to the outcome displayed as a game display to the player at block 222. The controller 152 may control the display 154 to display this information based on inputs from the player received via the input device 156.

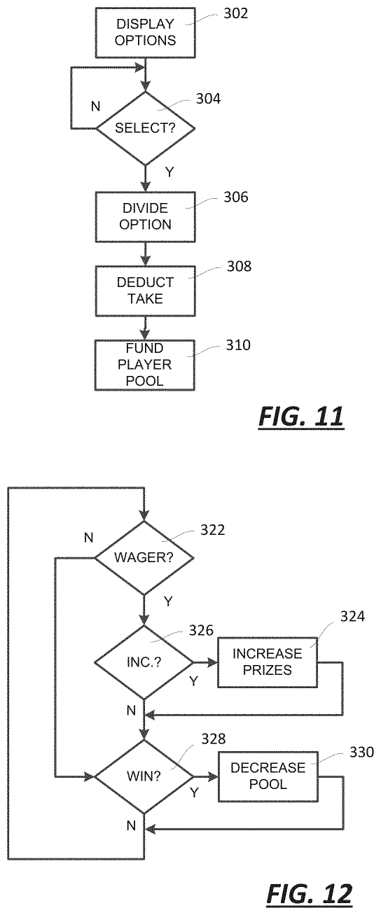

As mentioned above, FIG. 4 illustrates part of the operation of the system 100, while FIGS. 11 and 12 illustrate a further part of the operation of the system 100. In particular, the operation illustrated in FIGS. 11 and 12 relates to the pari-mutuel nature of the gaming and its relation to the wagers received at the gaming machines 102.

In general terms, those jurisdictions that permit pari-mutuel gaming require that the award for a win be equal to or greater than the amount wagered. In such a jurisdiction, the award for a win on a 2 credit wager (e.g., a US$2.00 wager) must be equal to or greater than 2 credits (e.g., a US$2.20 award).

In a conventional slot machine, it is very common for small awards to be provided to the player even when the amount wagered is much larger. For example, if a 50 credit wager is made to play all of the pay lines on a conventional slot machine, a win on even a single pay line out of the 50 pay lines played may result in an award to the player, which award will very likely be much less than the 50 credit wager (e.g., a 5 credit award).

As a consequence, a game that is utilizing an amusement display in the form of a slot-style amusement display will want to display a variety of symbol combinations, even symbol combinations that would be associated with award amounts that are smaller than the minimum wager required by the gaming machine. Such an amusement display will be more recognizable to the player using the amusement display as an indicator of the success of their wagering on the historical event data. To the end of providing a more recognizable, and thus more successful, amusement display, the gaming machine 102 is configured to provide for wagering in accordance with FIGS. 11 and 12.

As illustrated in FIGS. 11 and 12, the gaming system according to the embodiments described herein addresses the above issue of complying with local rules on pari-mutuel gaming by providing the player with a set of wager options, but allocating each option in the set of wager options as a set of wagers, each wager associated with a set of the races on which the player is wagering. The pari-mutuel rules are then applied to each wager within the set of wagers that are associated with an individual option presented to the player. That is, if a wager from the set of wagers is determined to be a win, then the award need only be equal to or larger than that wager, and not necessarily equal to or larger than the value of the wager option selected by the player.

As one example, consider a gaming machine with a pari-mutuel game using historical event data where it is desired have an amusement display similar to that of a slot machine that provides for a wager or bet on each pay line of a single credit (e.g. US$0.01). The gaming machine may provide a player with wager options corresponding to 25 pay lines, 30 pay lines, 40 pay lines and 50 pay lines. Because the player is wagering on historical event data (e.g., horse race data), the player is not actually placing a wager on the pay lines, but to permit the use of an amusement display where game symbols displayed along a single pay line could be a winner, the player is provided with four wager options: US$0.25 to play 25 lines (first wager option), US $0.30 to play 30 lines (second wager option), US$0.40 to play 40 lines (third wager option), and US $0.50 to play 50 lines (fourth wager option).

The gaming system 100 allocates a set of wagers to each wager option provided to the player. As illustrated in the following embodiments, the set of wagers may include two wagers. According to other embodiments, the set of wagers may include more than two wagers, or may even include only one wager. The set of wagers may even differ between the wager options: for example, one wager option may be associated with a set of wagers including only a single wager, while the other wager options may be associated with a set of wagers including two (or more) wagers. Where multiple wagers are included in each wager set, the allocations of a total wager amount among each of the individual wagers within the set may be in accord with one of the following embodiments, modified as necessary where more than two wagers are included in a set of wagers.

According to one embodiment, the first wager option is allocated as a first US $0.10 wager and a second US $0.15 wager. In a similar fashion, the second option is allocated as a first US $0.10 wager and a second US $0.20 wager, the third option as a first US $0.10 wager and a second US $0.30 wager, and the fourth option as a first US $0.10 wager and a second US $0.40 wager. It will be recognized that according to another embodiment, the first and second wager option may be allocated US $0.10/US $0.15 and US $0.10/US $0.20 as described above, while the third and fourth wager options may be allocated US $0.20/US $0.20 and US $0.20/US $0.30 instead. That is, it is not necessary to use the same amount for the first wager in each set of wagers associated with each wager option.

According to another embodiment, each wager option may be allocated as a set of wagers with the individual wagers allocated according to a common ratio. For example, a first wager option may be associated with a total wager amount of US $1.25 that is allocated US $0.25 to the first wager and US $1 to the second wager, or a ratio of 1:4. In a similar fashion, the second wager option may be associated with a total wager of US $2.50 that is allocated US $0.50 to the first wager and US $2.00 to the second wager, or again a ratio of 1:4.

According to a further embodiment, a plurality of wager options may include some wager options that are allocated into a set of wagers of which the first wager is a fixed amount (e.g., US $0.10) and the second wager varies according to the total wager amount, and some wager options that are allocated into a set of wagers of which the first and second wagers are in a particular ratio relative to each other. For example, the first and second wager options (associated with total wager amounts of US $0.25 and US $0.30) may be allocated US $0.10/US $0.15 and US $0.10/US $0.20, while third and fourth wager options (associated with total wager amount of US $1.25 and US $2.50) may be allocated according to a common ratio, such that the third wager option is associated with a set of wagers including a first wager of US $0.25 and a second wager of US $1.00 and the fourth wager option is associated with a set of wagers including a first wager of US $0.50 and a second wager of US $2.00.

As noted above, each wager option may correspond to a certain number of pay lines, as if the player were playing a slot machine, the pay lines instead associated with the amusement display where game symbols displayed along a pay line are associated with a prize event. For example, the wager options may correspond to 25 pay lines, 30 pay lines, 40 pay lines, and 50 pay lines. The number of wager options may be further increased by permitting each number of pay lines to be played at different bet depths or levels as well. For example, as to the wager option that corresponds to 25 pay lines, it may be possible to have a first wager option that corresponds to 25 pay lines and a wager of US $0.25, another that corresponds to 25 pay lines and a wager of US $0.50, a further that corresponds to 25 pay lines and a wager of US $0.75, and so on. Each of these wager options may be associated with a set of two wagers, and according to one embodiment, the total wager amount may be allocated as a first US $0.10 wager and a second wager (e.g., US $0.15, US $0.40, or US $0.65). According to another embodiment, a common ratio (e.g., 2:3) is used for each of the wager options associated with a common number of pay lines and a different bet depth, such that the first wager option is allocated to a first US $0.10 wager and a second US $0.15 wager, the second wager option is allocated to a first US $0.20 wager and a second US $0.30 wager, the third wager option is allocated to a first US $0.30 wager and a second US $0.45 wager, and so on. Either of these patterns (a fixed amount for the first wager or a common ratio for the wagers) could be repeated for each of the wager options associated with each of the other possible pay line groupings (e.g., 30 pay lines and a ratio of 1:2, 40 pay lines and a ratio of 1:3, and 50 pay lines and a ratio of 1:4). Still further embodiments may use different ratios for different wager options representing different bet depths and a common number of pay lines (per the amusement display).

According to the pari-mutuel rules that exist in many jurisdictions, the gaming system 100 may now payout to the player an award that is as small as US$0.10, even though the wager option that the player selected was US$0.25. Furthermore, according to this embodiment, the smaller wager/award may be provided across all wager options provided, thereby permitting the use of an amusement display that includes “winning” configurations along a very small number of pay lines, even potentially a single pay line. At the same time, because there is a second wager that increases in amount as the amount of the associated wager option increases, there is the potential for providing larger awards as well, which would be associated with amusement displays illustrating larger numbers of “winning” configurations along active pay lines.

According to an embodiment of the gaming system that operates according to the method of FIGS. 4, 11 and 12, the first wager in the set will be associated with a first group or set of races, and the second wager in the set will be associated with a second group or set of races. As mentioned above, the results of the first and second group of races may be compared to various patterns, where a match between the player's selections, the results of the group of races, and a particular pattern for that group of races results in an award. What the machine will display to the player is the composite of the awards for the wins (if any) associated with the first wager and the second wager.

As illustrated in the embodiment of FIG. 11, this portion of the method begins with the display of a plurality of wager options to the player by the system 100, or more particularly at the gaming machine 102, at block 302. According to the embodiment, the display of the wager options may include the display of a limited number of wager options, such as four or five wager options, for example. This information may be displayed to the player via the display 154, and the player may be prompted to use the input device(s) 156 to indicate which of the wager options the player wishes to select. The method continues to block 304, where the machine 102 waits to receive a signal from the input device(s) 156 corresponding to the selection of one of the wager options. The action of block 304 may be escapable at any time by the player, or the action of block 304 may expire after a time period has elapsed.

Once a wager option has been selected at block 304, the method 300 continues to block 306, where the wager option is divided into the set of wagers. For example, the wager option may be divided into a set of two wagers, as discussed above. It is possible for a wager option to be divided into more than two wagers as well. Each wager is associated with a group or set of races according to certain embodiments of the present disclosure, however. If each of those races were to be displayed along with the slot-style amusement display, as illustrated in FIG. 7, the display 154 may become dense with information if the wager were divided into more than two wagers. Accordingly, the discussion of the method 300 will assume that the set of wagers is a set of two wagers.

For each of the wagers within the set, a house take is deducted at block 308, which take is set aside. As for the remainder of each wager, it is contributed at block 310 to a player pool that is used to pay the awards for play of the game based on historical event data. According to certain embodiments, a certain percentage of each pool is used to fund a progressive award to be awarded to a player separately from the award determined one the basis of the historical event data that is part of the game as discussed with reference to FIG. 4.

In regard to block 310, the system 100 (e.g., the server 104) establishes a group or set of awards or prizes for each wager of the set of wagers, with each award determined according to one of a group or set of patterns associated with a group or set of races. Using the embodiment illustrated in FIG. 10 by way of example, each prize associated with each wager of the set of wagers may be associated with one of 18 different patterns illustrated, each pattern including five unique races and eight finishing positions for the five races (thereby defining an array or race card). As discussed with reference to the embodiment illustrated in FIGS. 5-7, the player may select, manually or automatically, horses for each of the eight finishing positions from twelve horses that competed in that race. Because each of the two wagers in the set of wagers is associated with a group of patterns for a set of five unique races, the player will need to select horses for 10 unique races in total according to this embodiment of the method.

Each of the wagers in the set of wagers may use the same set of patterns, such as is illustrated in FIG. 10, to determine if a prize associated with that pattern should be paid to a player participating in that prize. Because the patterns are distinguishable (i.e., no two patterns are the same), each wager in the set of wagers will be associated with, at most, a single winning pattern. Thus, each wager in the set of wagers will be associated with a single outcome for the set of patterns associated with the wager. It will be recognized that while the same set of patterns may be used for each wager in the set of wagers, it is also possible for different sets of patterns, and even different sets of distinguishable patterns (i.e., the patterns within the set are distinguishable from each other), to be used.

According to this embodiment, at least one prize in each group or set of prizes associated with a wager is of a value amount that is at least equal to, but not less than, the wager associated with that group or set of prizes. For example, if a US $0.10 wager is associated with a set of prizes, then at least one prize has a value amount of US $0.10. Similarly, a US $0.40 wager is associated with a set of prizes with at least one award of US $0.40, and so on. All of the other prizes within that set of prizes would then be associated with prizes that exceed the value associated with the at least one prize (the minimum prize or award)—for example, in the example where a minimum prize of US $0.10 is associated with a wager of US $0.10, the other prizes may be associated with prizes in the amount of US $0.15, 0.20, 0.25, 0.30, 0.35, 0.40, 0.45, 0.50, 0.55, 0.60, 0.75, 0.90, 1.00, 1.10, 1.25, 2.50 and 5.00. As mentioned above, the lower awards may be associated with patterns having fewer matches between player selections and finishing positions, while the higher awards may be associated with the patterns having a greater number of matches. According to such an embodiment, the prizes mentioned above may be matched with the patterns illustrated in FIG. 10 starting at the top left corner and wrapping at the end of each line to end in the bottom right corner.

While the prizes are discussed separately with respect to the patterns, it will be recognized that as a group, the group of prizes defines a pari-mutuel prize having a minimum amount that meets or exceeds the wager from the set of wagers associated with the prize. These prizes are won, or taken down, by correctly handicapping the group of races associated with the prize, according to the patterns associated with the group of races. Further, the value amount provided to the player is the sum of the prize awarded on the first wager in the set of wagers and the prize awarded on the second wager in the set of wagers, according to the embodiment discussed above.

Turning now to FIG. 12, the operation of the system 100 to fund and provide the prizes from the player pool is now discussed. A player pool may be associated with a number of prize groups, each prize group associated with a wager from a set of wagers. For example, a player pool may be associated with each of the two prize groups, a first pool/prize group for a wager of US$0.10 and a second pool/prize group for a wager of US$0.20. With each prize group, there may be a plurality of prizes, including a minimum prize that has a guaranteed amount equal to the wager associated with the prize group (e.g., a minimum prize of US$0.10 for a wager of US$0.10).

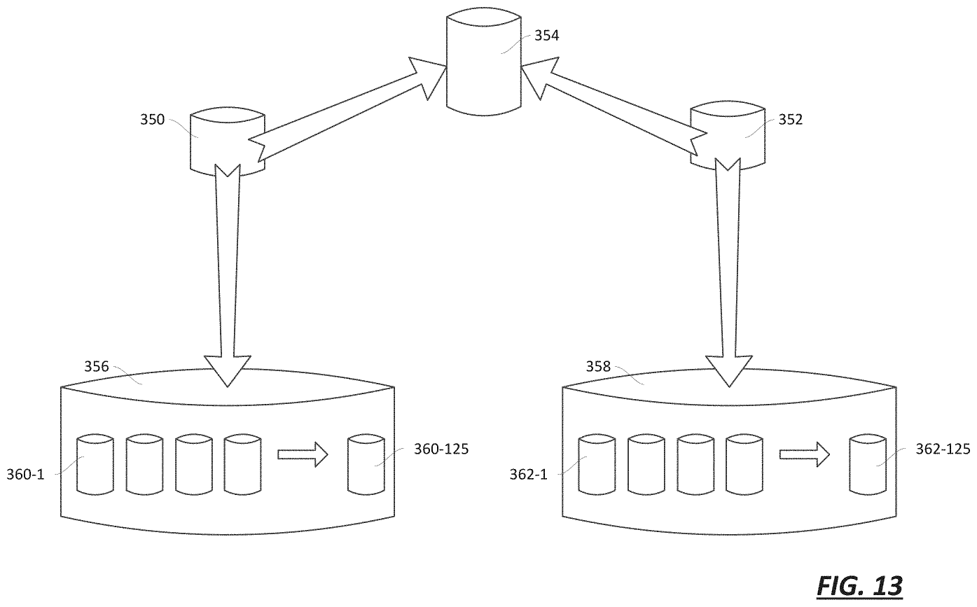

This is illustrated schematically in FIG. 13. A first wager 350 and a second wager 352 define a set of wagers. As indicated in FIG. 11, a percentage of the first wager 350 and the second wager 352 are deducted as a house take 354. The remainder of the value of the first and second wagers 350, 352 goes into a respective pool 356, 358.

As wagers are received into the respective pool 356, 358 at block 322, the system 100 may increase the individual prizes within each prize group at block 324. As such, a minimum prize that is initially a guaranteed US$0.10 will exceed this value as additional wagers are received. According to at least one embodiment, the prizes will be incremented a certain percentage of the wagers received by the player pool, e.g., 1% divided over all of the prizes associated with the pool.

Again, with reference to FIG. 13, the pool 356 is associated with the prizes 360 for the first wager 350, and the pool 358 is associated with the prizes 362 for the second wager 352. The prizes 360, 362 are of a certain guaranteed, fixed value amount, with the smallest value amount prize being at least equal to the value amount of the respective wager 350, 352. The prizes 360, 362 may be increased as the value received either at the first wager 350 or the second wager 352 increases. In the embodiment illustrated, there are 125 prizes 360 in the prize set associated with the first wager 350 (labeled 360-1 to 360-125) and 125 prizes 362 in the prize set associated with the second wager 352 (labeled 364-1 to 364-125), each prize associated with an adjustable amount that will increase as additional wagers are received.

According to the illustrated embodiment, the prizes 360, 362 are incremented only when a criterion has been met at block 326. For example, the system 100 may increment the prizes 360, 362 associated with a player pools 356, 358 only when the contributions from the player's wagers 350, 352 are sufficient to increment each prize 360, 362 by a set amount, for example US$ 0.01. As an illustration, if there are 125 prizes 360, 362 associated with each player pool 356, 358 (as illustrated in FIG. 13), then the prizes 360, 362 will not be incremented until each pool receives US$1.25 in contributions. Further, the prizes may each be incremented only in single units. As an illustration, if the division of the contribution of from the player's wagers 350, 352 would result in an increase of US$0.178 to each prize 360, 362, the prizes 360, 362 would instead be increased by US$0.17.

While the prizes 360, 362 may be increased according to the rules applied at block 326 of FIG. 12, the amount of the prize 360, 362 is not deducted from the pool 356, 358 until the system 100 determines that a win has occurred. Thus, each of the prizes 360, 362 may be represented by a counter that tracks the value associated with the prize as the prize is increased when additional wagers are received. At block 328, the system 100 makes a determination if one of the prizes should be paid (e.g., the pattern associated with that prize has occurred because of a matching of the player's selections and the finishing positions according to the pattern). If the determination is made that the prize is to be paid, then the pool 356, 358 is decreased by the amount of the prize paid, which prize would include the guaranteed amount and some additional amount added to the guaranteed amount 362, 364. As an illustration, where the wagers received have increased a prize having a guaranteed fixed value of US $0.10 by US$0.17, the total amount paid to the player would be US$0.27. Consequently, the player pool 356 is decreased by US$0.27.

It will be recognized that based on the payment of prizes 360, 362 from the pools 356, 358, it may be required from time to time to add funds to the pools 356, 358. This transfer may be performed by the operator of the system 100 into the pool 356, 358 as is necessary to ensure that the prizes may be paid.

According to certain embodiments, at least one of the prizes/counters in each of the pools 356, 258 may be associated with a progressive prize. This progressive prize is funded by the wagers 350, 352. Further, the method used to determine whether the progressive prize should be awarded may be the same as that used to determine if any of the other prizes should be awarded, i.e., matching a pattern associated with a group or set of races. The progressive prize may be paid out in the same fashion as other prizes, and after the progressive prize is paid, the progressive prize/counter may re-start at a guaranteed progressive prize value and increase from that value. In this sense, the progressive prizes/counters may be very similar to other prizes/counters 360, 362.

The progressive prize may be increased at a rate that is different from the rate at which the prizes 360, 362 are increased, however. Furthermore, where the number of progressive prizes associated with each pool 356, 358 is smaller than the total number of prizes, the progressive prizes will increase faster than the other prizes associated with the pools 356, 358 because the increase in prize value is distributed or shared among a smaller number of prizes/counters.

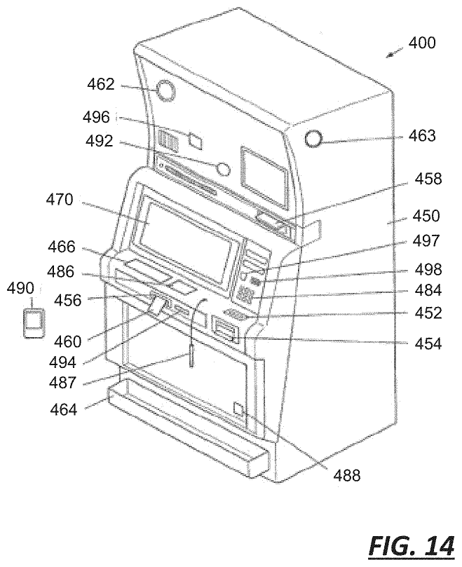

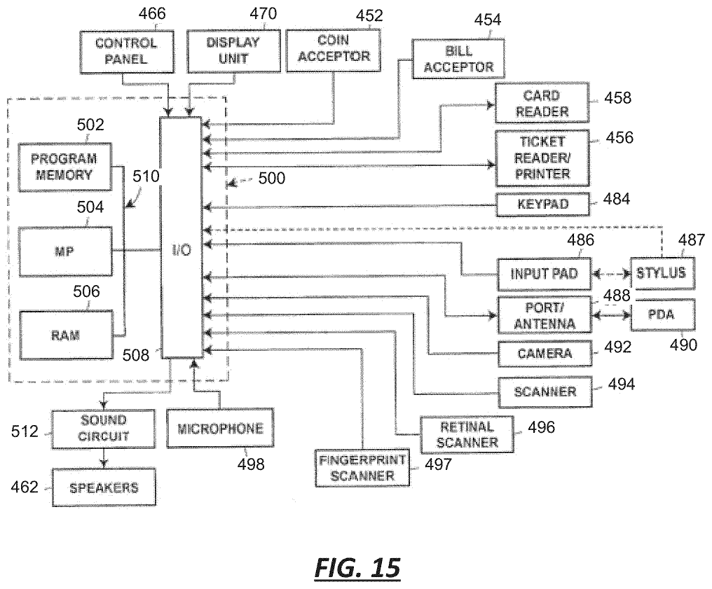

The methods described above may be carried out with the gaming machine 102 as illustrated in FIGS. 1 and 2. An alternative embodiment of gaming machine is illustrated in FIGS. 14 and 15.

Referring to FIG. 14, another embodiment of the invention is shown in the form of an electronic gaming machine 400. The electronic gaming machine 400 may include a housing or cabinet 450 and one or more value transfer mechanisms or devices, which may include a coin slot or acceptor 452, a paper currency or bill acceptor 454, a ticket reader/printer 456 and a card reader 458 as illustrated, which may be used to input value to the electronic gaming machine 400. In general terms, a value transfer device may include any device that can accept value from a player, wherein term “value” means credits, gaming tokens, coins, paper, currency, tickets, vouchers, credit cards, debit cards, smart cards, memory devices capable of storing value (e.g., a memory card, smart card, a radio frequency identification (RFID) device, USB key, magnetic card or other electronic storage device) and any other object representative of value, and a value transfer device may include an electronic funds transfer device.

If provided on the electronic gaming machine 400, the ticket reader/printer 456 may be used to read and/or print or otherwise encode ticket vouchers 460. The ticket vouchers 460 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 460 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 460 could be printed with an optically readable material such as ink, or data on the ticket vouchers 460 could be magnetically encoded. The ticket reader/printer 456 may be provided with the ability to both read and print ticket vouchers 460, or it may be provided with the ability to only read or only print or encode ticket vouchers 460. In the latter case, for example, some of the electronic gaming machines 400 may have ticket printers 456 that may be used to print ticket vouchers 460, which could then be used by a player in other electronic gaming machines 400 that have ticket readers 456.

If provided, the card reader 458 may include any type of card reading device, such as a magnetic card reader or an optical card reader, and may be used to read data from a card offered by a player, such as a credit card or a player-tracking card. If provided for player tracking purposes, the card reader 458 may be used to read data from, and/or write data to, player tracking cards that are capable of storing data representing the identity of a player, the identity of a casino, the player's gaming habits, etc.

The electronic gaming machine 400 may include one or more audio speakers 462, a coin payout tray 464, an input control panel 466, and a color video display unit 470 for displaying images relating to the game or games provided by the electronic gaming machine 400. The audio speakers 462 may generate audio representing sounds such as the noise of spinning reels, a dealer's voice, music, announcements or any other audio related to a game. The input control panel 466 may be provided with a plurality of pushbuttons or touch-sensitive areas that may be pressed by a player to select games, make wagers, make gaming decisions, etc. The buttons used may depend on the game or games that could be played on the electronic gaming machine 400. As used herein, the term “button” is intended to encompass any device that allows a player to make an input, such as an input device that must be depressed to make an input selection or a display area that a player may simply touch. For example, the control panel 466 could be generated by the display unit 470. In that case, each of the buttons of the control panel 466 could be a colored area generated by the display unit 470, and some type of mechanism may be associated with the display unit 470 to detect when each of the buttons was touched, such as a touch-sensitive screen.

The electronic gaming machine 400 also may include a mechanism by which the electronic gaming machine 400 may determine the identity of the player. In particular, the card reader 458 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 400 may also include equipment, such as a keypad 484, an input pad 486 (with optional stylus 487), a port (or antenna) 488 adapted to communicate via a wired or wireless link (infrared or radio frequency link, for example) to a mobile electronic device 490 (such as a personal digital assistant, smart phone or tablet), a camera 492, a scanner 494, a retinal (or iris) scanner 496, fingerprint scanner 497, and/or a microphone 498. The electronic gaming machine 400 may include any one of the devices 458, 484, 486, 488, 490, 492, 494, 496, 497, 498, or the electronic gaming machine 400 may include a combination of some or all of the devices 458, 484, 486, 487, 488, 490, 492, 494, 496, 497, 498.

In operation, a player may identify him or herself to the electronic gaming machine 400 by entering a unique numeric or alphanumeric code using the key pad 484, for example. Alternatively, the player may use his or her finger or the stylus 487 to sign his or her signature on the input pad 486. As a further alternative, the player may sign his or her signature on the mobile electronic device 490, which signature is then converted to electronic data, and the data is then transferred via the port/antenna 488 to the electronic gaming machine 400. As yet another alternative, the player may sign his or her signature on a piece of paper that is then photographed using the camera 492 or scanned using the scanner 494 (or the bill acceptor 454) to convert the signature into electronic data. As an additional alternative, the player may place one of his or her fingers or his or her hand on the scanner 497, and the scanner 497 may generate an electronic data representation of the fingerprint on one or more of the player's fingers or an electronic data representation of the pattern of the entire hand. Alternatively, the camera 492 may be used to take a picture (live or still) of the player, the picture then being converted into electronic data. As a still further alternative, the player may place his or her eye up to the retinal (or iris) scanner 496, and the retinal (or iris) scanner 496 may generate an electronic data representation corresponding to the pattern of the retina (or iris) of the player. As yet another alternative, the player may speak into the microphone 498, and characteristics of the spoken words (or voiceprint) may be converted into an electronic data representation.

FIG. 15 is a block diagram of a number of components that may be incorporated in the electronic gaming machine 400. Referring to FIG. 15, the electronic gaming machine 400 may include a controller 500 that may comprise a program memory 502, a microcontroller or microprocessor (MP) 504, a random-access memory (RAM) 506 and an input/output (I/O) circuit 508, all of which may be interconnected via an address/data bus 510. It should be appreciated that although only one microprocessor 504 is shown, the controller 500 may include multiple microprocessors 504. Similarly, the memory of the controller 500 may include multiple RAMs 506 and multiple program memories 502. Although the I/O circuit 508 is shown as a single block, it should be appreciated that the I/O circuit 508 may include a number of different types of I/O circuits. The RAM(s) 504 and program memories 502 may be implemented as semiconductor memories, magnetically readable memories, and/or optically readable memories, for example.

FIG. 15 illustrates that the coin acceptor 452, the bill acceptor 454, the ticket reader/printer 456, the card reader 458, the control panel 466, the display unit 470, the keypad 484, the input pad 486 (and optionally the stylus 487), the port/antenna 488, the digital camera 492, the scanner 494, the retinal scanner 496, the fingerprint scanner 497 and the microphone 498 may be operatively coupled to the I/O circuit 508, each of those components being so coupled by either a unidirectional or bidirectional, single-line or multiple-line data link, which may depend on the design of the component that is used. The speaker(s) 462 may be operatively coupled to a sound circuit 512, that may comprise a voice- and sound-synthesis circuit or that may comprise a driver circuit. The sound-generating circuit 512 may be coupled to the I/O circuit 508.

As shown in FIG. 15, the components 452, 454, 456, 458, 466, 470, 484, 486, 487, 488, 492, 494, 496, 497, 498, 512 may be connected to the I/O circuit 508 via a respective direct line or conductor. Different connection schemes could be used. For example, one or more of the components shown in FIG. 15 may be connected to the I/O circuit 508 via a common bus or other data link that is shared by a number of components. Furthermore, some of the components may be directly connected to the microprocessor 504 without passing through the I/O circuit 508.

It will be recognized that other embodiments of the electronic gaming device may include fewer than all of the components illustrated in FIGS. 14 and 15, but greater than the components illustrated in FIGS. 1 and 2. Further, it is possible for embodiments of the electronic gaming device to include components in addition to those illustrated either the embodiment of FIGS. 1 and 2 or the embodiment of FIGS. 14 and 15. These embodiments are provided for exemplary purposes only.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. An electronic gaming system for pari-mutuel wagering, comprising:
an electronic gaming machine, comprising a display, one or more input devices, a wager acceptor and a controller coupled to the display, the one or more input devices and the wager acceptor,
the controller configured to control the display to display a plurality of wager options, each of the wager options divided into a set of wagers, and to determine a selection of one of the wager options via the one or more input devices,
a first wager of the set of wagers of at least one of the wager options associated with a first set of awards and a second wager of the set of wagers of at least one of the wager options associated with a second set of awards,
the first set of awards determined based on the results of a first plurality of historical events, and the second set of awards determined based on the results of a second plurality of historical events.

2. The electronic gaming system according to claim 1, wherein a house take is deducted from each of the first and second wagers in the set of wagers.

3. The electronic gaming system according to claim 2, wherein an amount is deducted from each of the first and second wagers in the set of wagers for a progressive prize, and a remainder from each of the first and second wagers is contributed to a pool that is used for each of the first and second sets of awards.

4. The electronic gaming system according to claim 2, wherein a remainder from each of the first and second wagers is contributed to a pool that is used for each of the first and second set of awards.

5. The electronic gaming system according to claim 4, wherein the results of the first plurality of historical events are compared to a first plurality of result patterns to determine the first set of awards, and the results of the second plurality of historical events are compared to a second plurality of result patterns to determine the second set of awards, wherein each pattern in the first and second pluralities of patterns is associated with a prize.

6. The electronic gaming system according to claim 5, wherein each prize comprises a minimum prize and an additional amount.

7. The electronic gaming system according to claim 5, further comprising a server, the server managing the pools and the prizes associated with each pattern in the first and second pluralities of patterns.

8. The electronic gaming system according to claim 1, wherein the first set of awards are determined based on the results of a first plurality of historical racing events, and the second set of awards are determined based on the results of a second plurality of historical racing events.

9. The electronic gaming system according to claim 8, wherein the results of the first plurality of historical racing events are compared to a first plurality of result patterns to determine the first set of awards, and the results of the second plurality of historical racing events are compared to a second plurality of result patterns to determine the second set of awards.

10. The electronic gaming system according to claim 1, wherein the controller controls the display to display video for each of the first plurality of historical events, and to display video for each of the second plurality of historical events.

11. The electronic gaming system according to claim 10, wherein the controller controls the display to display an amusement display comprising a plurality of game symbols arranged to define an array, one or more configurations of the game symbols related to the results of the first and/or second plurality of historical events.

12. The electronic gaming system according to claim 11, wherein the one or more configurations of game symbols appear along one or more active paylines.

13. A method of operating an electronic gaming system for pari-mutuel wagering, the method comprising:
displaying a plurality of wager options, each of the wager options divided into a set of wagers;
determining a selection of one of the wager options via the one or more input devices,
a first wager of the set of wagers of at least one of the wager options associated with a first set of awards and a second wager of the set of wagers of at least one of the wager options associated with a second set of awards,
determining the first set of awards based on the results of a first plurality of historical events; and
determining the second set of awards based on the results of a second plurality of historical events.

14. The method according to claim 13, further comprising deducting a house take from each of the first and second wagers in the set of wagers.

15. The method according to claim 14, further comprising:
deducting an amount from each of the first and second wagers in the set of wagers for a progressive pool; and
contributing a remainder from each of the first and second wagers to a pool that is used for each of the first and second sets of awards.

16. The method according to claim 14, further comprising contributing a remainder from each of the first and second wagers to a pool that is used for each of the first and second set of awards.

17. The method according to claim 16, further comprising:
comparing the results of the first plurality of historical events to a first plurality of result patterns to determine the first set of awards; and
comparing the results of the second plurality of historical events to a second plurality of result patterns to determine the second set of awards,
wherein each pattern in the first and second pluralities of patterns is associated with a prize.

18. The method according to claim 17, wherein each prize comprises a minimum prize and an additional amount.
